(19) United States
(12) Patent Application Publication
(10) Pub. No.: US 2008/0145626 A1
(43) Pub. Date: Jun. 19, 2008

(54) BOSSED LASER VALIDATION FORM

(75) Inventors: Scott T. Ginkel, Stillwater, MN (US); Sundar J. Rajan, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/611,393

(22) Filed: Dec. 15, 2006

(51) Int. Cl. B32B 7/12; B05D 3/12; B41M 3/14; B32B 38/06; B32B 3/08

(52) U.S. Cl. 428/198; 427/275; 427/7; 156/219; 428/195.1

(57) ABSTRACT

Various embodiments of the present application relate to new form constructions and methods of forming and using the new form constructions. One method of printing a form construction involves (1) providing a substrate having a first major surface and a second major surface; (2) bossing at least a portion of the substrate to form a bossed substrate portion; and (3) attaching a signage to the bossed substrate portion. The signage or a printable portion of the substrate may then optionally be printed. An exemplary new form construction includes a substrate having a bossed substrate portion and an unbossed substrate portion; and a signage adjacent to the bossed substrate portion.

### BACKGROUND

It is often desirable to supply a decal, sticker, or label to a recipient. Typically the decal, sticker, or label is releasably adhered to the form that is supplied. The recipient removes the decal from the form and applies it to an appropriate item, such as, for example, a membership card, a vehicle window, or a license plate. FIG. 1 is a top view of an exemplary prior art form construction in which the exemplary form is a certificate of vehicle registration, generally denoted as 10. Form 10 includes a substrate 11, typically paper, on which is releasably attached a validation sticker 12. Validation sticker 12 is releasably attached via a release liner or release coating 14. Validation stickers typically have a printable top surface and a pressure sensitive adhesive (PSA) on the bottom with a protective liner that is removed before it is adhered to the ultimate surface such as an automobile license plate.

Two exemplary prior art form constructions are shown in FIGS. 2 and 3 and described in U.S. Pat. No. 6,406,787, which is commonly assigned to the assignee of the present application. FIGS. 2 and 3 are cross-sectional views of exemplary form constructions for use with the prior art form 10 of FIG. 1. In FIG. 2, a release coating 14a is coated onto a portion of substrate 11. A validation sticker 12 onto which is applied an adhesive 16 is releasably attached to release coating 14a. In FIG. 3, release coating 14b is coated onto the entire area of substrate 11.

Another exemplary prior art form construction is shown in FIG. 4 and described in U.S. Pat. No. 6,092,843. The form 10 includes a carrier sheet 18, typically paper, with a cutout 20 therein. A patch 22 (for example, glassine) is adhered by adhesive 24 to the bottom of carrier sheet 18. Validation sticker 12 and adhesive 16 are attached to patch 22 by a spot coating of adhesive release material 26.

The prior art form constructions have several drawbacks. First, the stickers extend above the top surface of the substrate. For example, the stickers in FIGS. 2 and 3 extend above the substrate anywhere from approximately 0.005 inch to about 0.015 inch. During manufacturing and/or use, the forms may be stacked as they exit the converting process or printer. The form being added to the stack 30 tends to “catch” on the validation sticker 32 on the topmost form in the stack 34, as is shown in FIG. 5. This may cause media jamming problems in the converting process or the form entering the stack to curl up and in some cases, flip over, which in turn can destroy the form. Further, the sticker on the form in the stack may be pulled off from the substrate, thereby destroying the form in the stack. Consequently, these prior art form constructions are associated with manufacturing waste, decreased manufacturing productivity, increased manufacturing cost, and decreased manufacturing efficiency.

The sticker construction in FIG. 4 slightly minimizes the incidence of the incoming form catching on the existing form in the stack because the validation sticker protrudes above the carrier sheet less than the stickers in the embodiments shown in FIGS. 2 and 3. However, the validation sticker in FIG. 4 nonetheless protrudes above the carrier substrate and may catch on the existing form in the stack. Further, the adhesive used to attach the glassine to the substrate can at least partially melt when exposed to the high temperature environment of the printer, causing adhesive to “ooze” out the edges of the form and create handling problems as the form passes through the printer. Thus this prior art form construction also is associated with manufacturing waste, decreased manufacturing productivity, increased manufacturing cost, and decreased manufacturing efficiency.

It is therefore, desirable to have improved form constructions and methods of making and using the improved form construction.

### SUMMARY

Various embodiments of the present application relate to new form constructions and methods of forming and using the new form constructions. One method of printing a form construction involves (1) providing a substrate having a first major surface and a second major surface; (2) bossing at least a portion of the substrate to form a bossed substrate portion; and (3) attaching a signage to the bossed substrate portion. Optionally, one or both of the signage and the substrate may be printed. An exemplary new form construction includes a substrate having a bossed substrate portion and an unbossed substrate portion; and a signage adjacent to the bossed substrate portion. In one embodiment, the signage is releasably attached to the bossed portion. In another embodiment, the signage is placed within a well or depression in the bossed portion such that the uppermost surface of the signage does not appreciably extend above the uppermost surface of the substrate. One advantage of this form construction is that because the signage does not appreciably extend or protrude above the substrate, the improved forms do not catch on one another during processing or stacking.

The type of form to which the form construction and methods described in the present application can be applied is not limited, and the inventors intend this disclosure to include all forms including a signage. Examples of such forms and signage include validation stickers, indoor/outdoor labeling products, product authentication articles, inventory labeling and control articles, window stickers and inspection stickers for automobiles and other equipment, parking permits, expiration stickers, etc.

The improved form constructions described in the present application have various advantages over prior art form constructions, some of which are described below. First, because the signage does not appreciably extend above the uppermost surface of the substrate, the form does not “catch” on other forms during processing, printing, and storage. Consequently, fewer forms are destroyed during manufacturing and/or use, which increases manufacturing efficiency and decreases manufacturing costs as well as reducing waste. Second, the print quality of the forms improves, in part, because the signage is approximately the same planar height as the substrate, facilitating more even application of printer ink or toner to the signage and to the substrate. Third, the form construction does not use a glassine portion, thereby decreasing the materials cost and eliminating the incidence of the adhesive that holds the glassine to the substrate heating when the substrate is passed through a printer and then “oozing” onto the substrate, signage, printer, or other surface or having the glassine “catch” during processing, printing, and/or storage.

### BRIEF DESCRIPTION OF THE DRAWINGS

The present application will be further explained with reference to the appended Figures, wherein like structure is referred to by like numerals throughout the several views, and wherein:

FIG. 1 is a top view of an exemplary prior art form construction in which the exemplary form is a certificate of vehicle registration.

FIGS. 2 and 3 are cross-sectional views of exemplary form constructions for use in the form of FIG. 1.

FIG. 4 is a cross-sectional view of another exemplary prior art form construction for use in the form of FIG. 1.

FIG. 5 is a schematic diagram of a form construction of the type shown in FIG. 1 “catching” on another form construction of the type shown in FIG. 1.

FIGS. 6-9 are cross-sectional views of exemplary embodiments of an improved form construction.

FIGS. 10a and 10b are top views of exemplary improved form constructions.

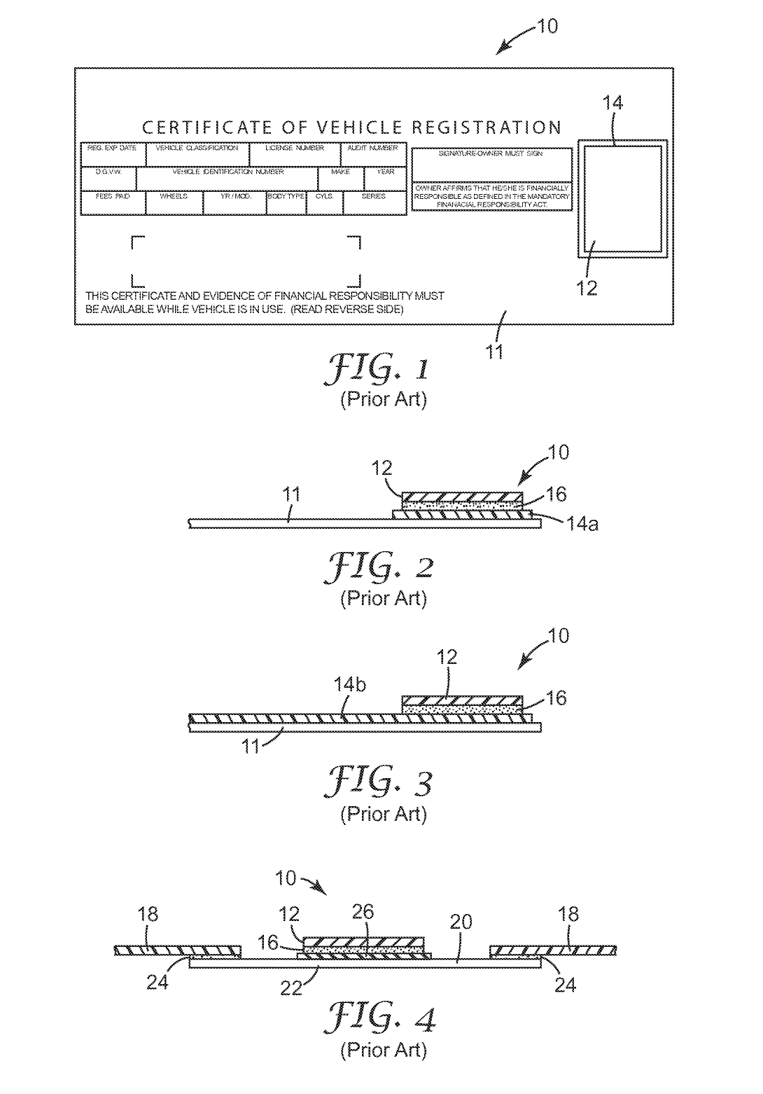

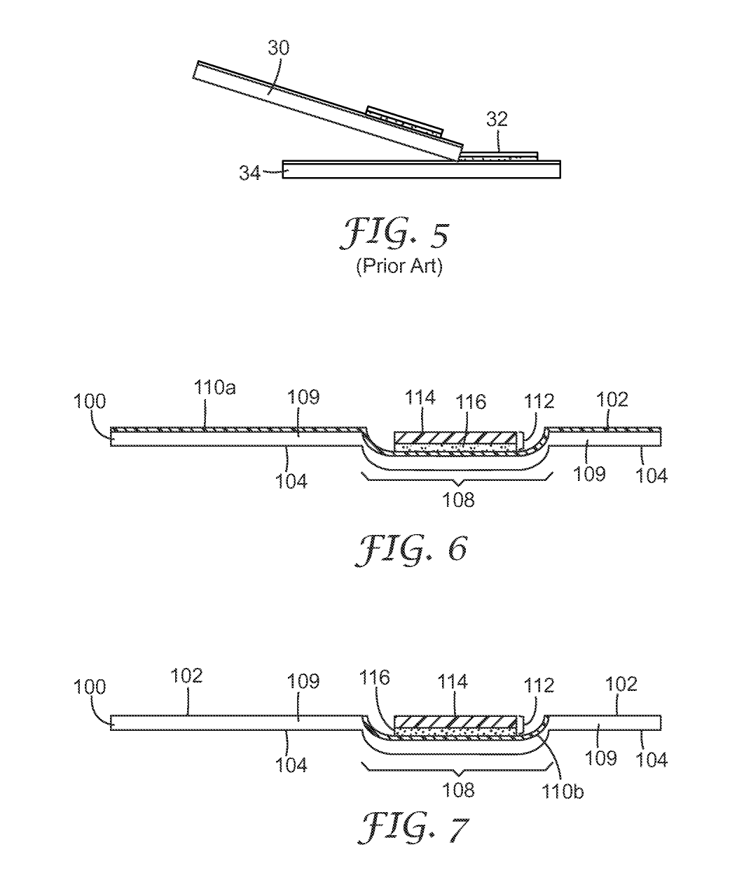

### DETAILED DESCRIPTION

One embodiment of an improved form construction is shown in FIG. 6. A substrate 100 having opposed first major surface 102 and second major surface 104 includes a bossed portion 108 and an unbossed portion 109. As shown in FIG. 6, bossed portion 108 forms a depression or well in substrate 100. Substantially all of first major surface 102, including the portion of first major surface 102 that is a part of the bossed portion 108, is coated with a release coating 110a. A signage 112 including a sticker, decal, or label 114 and an adhesive layer 116 is placed within the depression or well formed by bossed portion 108 such that the upper surface of sticker 114 does not appreciably extend above first major surface 102 of substrate 100.

Another embodiment of an improved form construction is shown in FIG. 7 and is substantially the same as the form construction shown in FIG. 6 except that release coating 110b only covers a portion of first major surface 102. Specifically, as shown in FIG. 7, release coating 110b covers the portion of first major surface 102 that includes the depression or well formed by bossed portion 108.

Another embodiment of an improved form construction is shown in FIG. 8 and is substantially the same as the form construction shown in FIG. 6 except that signage 112 includes a release liner 130 in addition to sticker, decal, or label 114 and adhesive layer 1 16. Further, an adhesive 132 layer is positioned adjacent to at least a portion of the release liner 130.

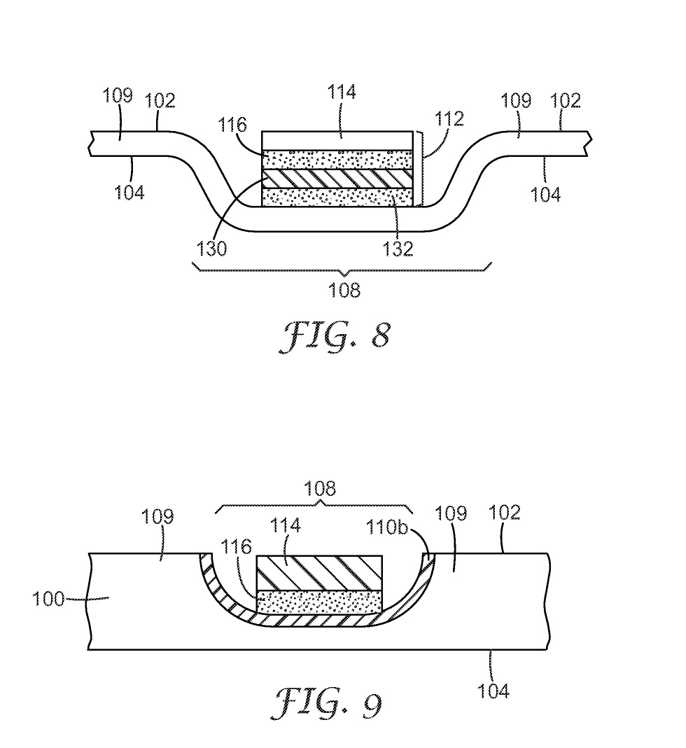

Those of skill in the art will appreciate that all of the improved form constructions shown above and covered by the attached claims may appear as shown in FIG. 9. Specifically, the second major surface 104 of substrate 100 may be flat rather than curved, as is shown in FIGS. 6-8. The improved form constructions of the type shown in FIG. 9 include a bossed portion 108 that forms a depression or well and an unbossed portion 109. The bossing process creating boss portion 108 compresses a portion of substrate 100, thereby causing the thickness of substrate 100 in the area of bossed portion 108 to be less than the thickness of substrate 100 in unbossed portion 109. Consequently, the second major surface 104 of substrate 100 remains substantially flat in the area of bossed portion 108. Those of ordinary skill in the art will recognize that the form construction shown in FIG. 9 can also be formed by removing a portion of substrate 100 to form the depression or well in bossed portion 108. Removal of a portion of substrate 100 is considered one exemplary method of bossing with respect to the present application.

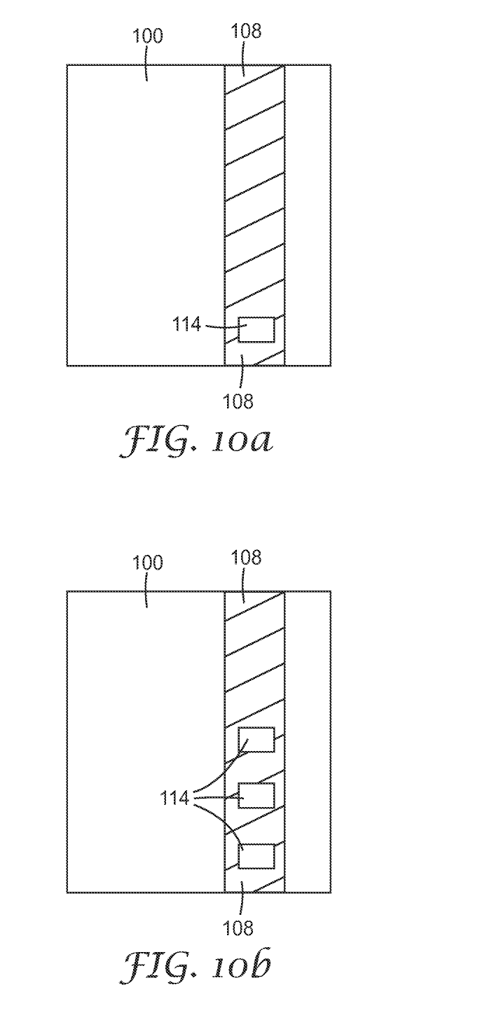

Additional embodiments of an improved form construction are shown in FIG. 10a and 10b. In FIG. 10a, the bossed portion 108 extends the length of substrate 100. Indeed, the present application includes bossing any portion of substrate 100. In FIG. 10b, multiple stickers, decals, or labels 114 are positioned adjacent to substrate 100, at least one of which is positioned within the area of bossed portion 108.

One exemplary method of making the improved form constructions described above involves (1) providing a substrate having a first major surface and a second major surface; (2) bossing at least a portion of the substrate to form a bossed substrate portion; and (3) placing a signage adjacent to the bossed substrate portion. The substrate may be documented or non-documented (printed or unprinted) before the signage is placed adjacent thereto.

Another exemplary method further includes printing on a printable portion of the substrate or on the signage. Such printing may be effected by any appropriate printing method including, but not limited to, digital printing (including, not limited thereto, laser, ink-jet, thermal mass transfer, thermal dye transfer, electrostatic, ion deposition, electron beam imaging, solid ink-jet and dot-matrix printing), thermal printing, flexographic printing, letter press, and gravure printing. More detailed information regarding some of the printing processes that can be used in the methods of the present application are available in commonly assigned U.S. Pat. No. 6,406,787 as well as in standard printing textbooks. Examples of such books include Principles of Non Impact Printing, by J. L. Johnson, Palantino Press (1986); Understanding Digital Color, by Phil Green, Graphic Arts Technical Foundation (1995), pp 293-310; and Pocket Pal, A Graphic Arts Production Handbook, edited by M. Bruno, International Paper Co., 16.sup.th edition (1995), pp. 126-150. Where both the substrate and the signage are printed, separate printers or the same printer may be used to print on the signage and the substrate. Also, printing may occur in a single step or process or may occur in separate steps or processes.

Another exemplary method further includes applying a release material to at least a portion of the substrate. As is shown in FIGS. 6 and 7, the release material may be applied to only a portion of the substrate, such as to the bossed substrate portion, or to substantially all of one or both of first and second major surfaces of the substrate. The release material is preferably applied at least to the portion of the substrate to which the signage will be adjacent.

The release material is not particularly limited but it is preferred that the release material is heat and humidity stable since certain printing operations (such as laser printing and thermal transfer printing) involve a heat treatment process. By “heat and humidity stable,” applicant means that there is no substantial adhesion loss (an adhesion loss of preferably less than 10%, more preferably less than 5%) of a signage when a form with a signage is placed in a humid atmosphere or is printed. The release material may be applied, for example, by spray-coating, gravure, flexographic, electrostatic, ink jet, letter press, extrusion, hot melt, die coating, and other similar methods. Exemplary release materials include silicone coatings, fluorochemical coatings, acrylic coatings, perfluorether coatings, other similar coatings, and copolymers, mixtures, and blends thereof. It is desirable to use a printable release material where at least a portion of the substrate will be printed. Exemplary printable release materials include those described in commonly assigned U.S. Pat. No. 6,406,787. As is shown in FIGS. 6 and 7, the signage may be positioned adjacent to the release material. The bossing, coating with release material, and drying of the release material may be part of a single manufacturing step, process, or pass or may be part of multiple steps, processes, or passes.

As used herein, the term “substrate” is meant to include any substrate or print medium known in the art, including, but not limited to, paper, plastic, synthetic paper, metal foil, vinyl, foam, and variations thereof. The term paper is meant to include security paper. Paper is one exemplary preferred substrate.

As used herein, the term “bossing” is meant to refer to methods that form a well, depression, or bossed area in a substrate or that otherwise provide at least a portion of the substrate with three-dimensionality where the substrate was once planar. These methods include embossing, debossing, substrate material removal, and the like. Common embossing methods include using an embossing die(s) on a flexographic printing press, letter press, gravure printing press, other type of embossing tool, a machine equipped with an embossing tool, and the like. As the substrate is advanced through the manufacturing process, one or more of the stations in the process can be a bossing station. Alternatively, each sheet or multiple sheets can be individually bossed using bossing equipment. The substrate can be bossed when in roll or sheet form. The substrate may be bossed on either of first major surface or second major surface. The size, shape, and depth of the bossed portion typically depends on the size and shape of the bossing dies. The process of bossing the substrate may result in compression of the bossed portion of the substrate such that the thickness of the substrate in the bossed area is less than the thickness of the unbossed area of the substrate, as is shown in FIG. 9. The size of the bossed substrate portion is preferably the same as or slightly larger than the size of the signage such that the signage preferably sits within the bossed portion. The signage is preferably approximately centered in the bossed portion, but may be placed anywhere within the bossed portion. As those of ordinary skill in the art will recognize, the depth of the well or depression in the bossed portion may change when the form is passed through a printer. For example, the depth of the bossed portion may significantly decrease when the form is passed through the printer such that the bossed portion is no longer noticeable.

As used herein, the term “signage” is meant to include a sticker, label, decal, or the like. Signage is also meant to optionally include an adhesive and/or a release material. A signage article is typically applied to a substrate such that the pressure sensitive adhesive provided on a rear surface of the signage article is adjacent to the substrate. The resulting form sheet/construction with the signage article attached thereto can be treated as one-piece during a process including printing, and the signage article should be releasable from the form sheet so that the signage can be applied to the ultimate surface after the printing process. A signage article typically has a substrate and a marking material in addition to a pressure sensitive adhesive. A signage article may include a substrate having an organic polymeric surface, a radiation cured coating disposed on the organic polymeric surface, and optionally a marking material disposed thereon (which form indicia such as numbers, letters, etc.). As described before, the marking material may have been disposed on the surface of the signage article before the signage article is applied to a form sheet, or/and the marking material may be provided on the surface of the signage article by printing after the signage article is applied to a form sheet. The sticker, label, or decal portion of the signage may include retroreflective, reflective, colored, white, transparent, translucent, patterned, opaque, or the like materials. The stickers, labels, or decals may include variable information that can be printed by, for example, screen printing, letter press, offset, laser, thermal transfer printing technologies, or the like. In many embodiments, information will be readable to the unaided eye and may be in the form of selected alphanumeric characters or other symbols, e.g., bar codes, emblems, etc., in desired colors. If desired, the information may be readable by others means, e.g., machine readable infrared images. At least a portion of the sticker, label, or decal may include a protective coating, such as mylar, that may, for example, preserve the integrity of the variable information that is printed on the sticker, label, or decal. Retroreflective polymeric sheeting is the preferred signage article of the present application and may include, for example, “beaded sheeting” in the form of an encapsulated-lens sheeting (see, for example, U.S. Pat. Nos. 3,190,178; 4,025,159; 4,896,943; 5,064,272; and 5,066,098), enclosed-lens sheeting (see, for example, U.S. Pat. No. 2,407,680), or may comprise a cube corner retroreflective sheeting (see, for example, U.S. Pat. Nos. 3,684,348; 4,801,193; 4,895,428; and 4,938,563). Additional information regarding signage articles is provided in commonly assigned U.S. Patent No. 6,406,787.

Suitable tacky pressure sensitive adhesives (PSAs) for use in signage of the present application are typically and preferably aggressively and permanently tacky at room temperature, adhere to substrates without the need for more than hand pressure, and require no activation by water, solvent or heat. Suitable PSAs are disclosed, for example, in U.S. Pat. No. 5,725,935 (Signage Articles Methods of Making the Same), which is herein incorporated by reference.

Tacky PSAs suitable in the present application are preferably selected from the group consisting of alkylacrylate polymers and copolymers; copolymers of alkylacrylates with acrylic acid; terpolymers of alkylacrylates, acrylic acid, and vinyl-lactates; alkyl vinyl ether polymers and copolymers; polyisoalkylenes; polyalkyldienes; alkyldiene-styrene copolymers; styrene-isoprene-styrene block copolymers; polydialkylsiloxanes; polyalkylphenylsiloxanes; natural rubbers; synthetic rubbers; chlorinated rubbers; latex crepe; rosin; cumarone resins; alkyd polymers; and polyacrylate esters and mixtures thereof. Examples include polyisobutylenes, polybutadienes, or butadiene-styrene copolymers, and mixtures thereof (such polymers and copolymers preferably have no reactive moieties, i.e., are not oxidized in the presence of air); silicone-based compounds such as polydimethylsiloxane, and polymethylphenylsiloxane combined with other resins and/or oils.

Other suitable tacky PSAs also include tackified thermoplastic resins and tackified thermoplastic elastomers, wherein the tackifier comprises one or more compounds which increases the tack of the composition. An example of a tackified thermoplastic resin useful as an aggressively tacky PSA is the combination of a vinyl acetate/ethylene copolymer known under the trade designation VYNATHENE EY 902-30 (available from Quantum Chemicals, Cincinnati, Ohio) with substantially equal portions of the tackifiers known under the trade designations PICCOTEX LC (a water-white thermoplastic resin produced by copolymerization of vinyltoluene and alpha-methylstyrene monomers having a ring and ball softening point of about 87°-95° C., available from Hercules Incorporated, Wilmington, Del.) and WINGTACK 10 (a liquid aliphatic C-5 petroleum hydrocarbon resin available from Goodyear Chemical) and an organic solvent such as toluene. An example of a tackified thermoplastic elastomer useful as an aggressively tacky PSA is the combination of the styrene-poly(ethylene-butylene)-styrene block copolymer known under the trade designation KRATON G1657 (available from of Shell Chemicals) with one or more of the low molecular weight hydrocarbon resins known under the trade designation REGALREZ (from Hercules) and an organic solvent such as toluene. Both of these formulations may be coated using a knife coater and air dried, or air dried followed by oven drying. Of course, the inventive concept, claims, and patent application are not limited to use of these specific combinations of thermoplastic resins, thermoplastic elastomers, and tackifiers.

Some presently preferred PSA's exhibit extended shelf life and resistance to detackifying under atmospheric conditions, and include acrylic-based copolymer adhesives as disclosed in U.S. Pat. No. Re 24,906. One example of such an acrylic-based copolymer is a 95.5:4.5 (measured in parts by weight of each) isooctylacrylate/acrylic acid copolymer. Another preferred adhesive is the copolymer of a 90:10 weight ratio combination of these two monomers. Yet other preferred adhesives are terpolymers of ethyl acrylate, butyl acrylate, and acrylic acid; copolymers of isooctylacrylate and acrylamide; and terpolymers of isooctylacrylate, viny-lacetate, and acrylic acid.

Tacky acrylic PSAs useful in the forms and methods of the present application can be coated out of a coatable composition comprising an organic solvent, such as a heptane:isopropanol solvent mixture, and the solvent subsequently evaporated, leaving a pressure-sensitive adhesive coating. This layer is preferably from about 0.038 centimeters (cm) to about 0.11 cm (5 to 15 mils) thick when the substrate is a retroreflective sheeting material.

As used herein, “tack” refers to the property of a material which enables it to form a bond of measurable strength immediately on contact with another surface (see, e.g., ASTM D1878-61T (1957). A common piece of test equipment used by ASTM is a Polyken probe tack tester, which, according to Handbook of Adhesives, 3rd Ed. p. 656(1990), comprises a 5 millimeter diameter flat-ended rod (usually steel) connected to a load cell. The instrument mechanically lifts the probe to make contact with the PSA, holds it there for a preset time of contact, variable in 10 steps from 0.1 to 100 seconds, and then withdraws the probe at a controlled speed, which can be varied in steps from 0.02 to 2 cm/sec. The PSA, on some backing, is attached to the flat bottom of an inverted metal cup with a hole in the bottom through which the probe enters. Thus, the contact pressure can be varied using by using cups or annular weights of various masses. The most common test conditions reported are 100 g/cm contact pressure, 1 second contact time, and 1 cm/sec withdrawal speed (commonly denoted using the shorthand notation “100, 1, 1”).

Experimental values of Polyken probe tack are expressed in terms of gram force, with all conditions specified. In the present application, the phrases “tacky” and “aggressively tacky” are used interchangeably and mean the PSA in question suitably has a probe tack as measured in accordance with ASTM D 1878-61T of at least 500 g (100, 1, 1), preferably at least 1000 g; while the term “non-tacky” means the PSA in question has a tack of at most 400 g (100, 1, 1).

Tacky PSAs useful in the methods and forms described in the present application also may be characterized by having “180° peel adhesion” ranging from about 170 to about 1000 gm/cm, more preferably ranging from about 390 to about 560 gm/cm, measured using a standard test procedure. In this procedure, the force necessary to remove (i.e. peel) a PSA-coated substrate from a test substrate when the PSA-coated substrate is peeled from the test substrate is termed the “peel adhesion” value. A standard glass plate is cleaned using a solvent (such as one wash of diacetone alcohol followed by three washes of n-heptane). With pressure, a sample having a PSA-backsize coating is then applied along the center of the standard glass plate, PSA side down. The sample is then rolled once with a 2.04 Kg hand roller. The standard glass plate is then secured to a horizontal platen in a standard peel adhesion tester such as that known under the trade name “IMASS.” One end of the sample is then attached to a hook which is a part of the peel adhesion tester. The sample is peeled from the standard glass plate at a 180° angle (i.e., one end of the sample is pulled toward the other end) by moving the platen horizontally at a speed of 228.6 cm/min, and the force required recorded, in gm/cm of sample width, for various dwell times.

The signage may be attached to the substrate in any way known to those of skill in the art. Exemplary attachment methods include the use of a releasable material, use of a pressure sensitive adhesive, use of a “piggyback” construction (similar to that shown in FIG. 8).

The following example described the construction and process for constructing one embodiment of the form construction of the present application.

### EXAMPLE I

A roll of paper web (e.g., Value paper manufactured by Boise Cascade Inc.) or plastic web (e.g., PrintMaster® Laser sheets such as C1S and C2S manufactured by Protect-all Print Media, Inc. and V-MAX® Printing Films manufactured by Valeron® Strength Films) measuring approximately 0.0045 inches (0.0114 cm) thick, 9.5 inches (24.1 cm) wide and 20,000 lineal feet in length is coated with a solvent-based release coating of the type described in Example 2 of U.S. Pat. No. 6,406,787. The release coating is applied to the web in one pass using a gravure coating process. The release coating is dried in an oven at 280° F. (138° C.) for 5 minutes to evaporate the solvent.

The release coated roll of paper or plastic web is installed on the unwind arbor of a flexographic printing press, such as a press commercially available and manufactured by Mark Andy, Inc., which contains print stations and web converting modules. The input web passes through print stations on the flexographic press at which time indicia may be printed on the top and/or bottom surface of the web.

After passing through the print stations, the web is passed through a die bossing converting module, such as a module commercially available and manufactured by Mark Andy, Inc. An interfering (male/female) die assembly or a non-interfering die assembly, both commercially available from die suppliers such as Wilson Manufacturing and Rotometrics Inc., is installed in the converting module. The depth of bossing typically ranges from 0.0001 inch (0.0003 cm) to approximately 0.008 inch (0.02 cm). Pressure is applied to the bossing die by manual screw adjustment or by a pneumatic or hydraulic pressure apparatus to achieve the appropriate bossing depth.

After a rectangular area of approximately 1.75 inches×1.25 inches (4.445 cm×3.175 cm) is bossed, the web proceeds through a sticker application station where a 3M™ Scotchlite Retroreflective Sticker is applied into the recess of the embossed rectangular area using label application equipment commercially available from suppliers such as Label-Aire, Paragon Labeling Systems, Accraply Inc., Weber Labeling & Coding Systems, and Labeling Systems Inc.

After the sticker has been applied into the recess of the embossed rectangular area, lines of weakness (e.g., perforations) may be formed or the web may be cut into a desired length using a rotary die. Perforation and rotary dies are commercially available from suppliers such as Wilson Manufacturing and Rotometrics Inc. After the web has been cut into 8.5 inch×11 inch (21.6 cm×28 cm) sheets, the sheets are packaged for commercial use.

The complete disclosures of all patents, patent applications, patent documents, and publications are incorporated herein by reference as if individually incorporated.

Various modifications and alterations of the methods and forms described in the present application will become apparent to those skilled in the art without departing from the spirit and scope of the inventive concept. The invention is intended to encompass all such modifications and alterations within the scope of the appended claims.

What is claimed is:

1. A method of printing on a substrate, comprising:
providing a substrate having a first major surface and a second major surface;
bossing at least a portion of the substrate to form a bossed substrate portion; and
placing a signage adjacent to the bossed substrate portion.

2. The method of claim 1, in which the substrate is selected from a group consisting essentially of paper, plastic, synthetic paper, metal foil, and vinyl.

3. The method of claim 1, in which the signage is selected from a group consisting essentially of a validation sticker, an indoor/outdoor labeling product, a product authentication sticker, an inventory labeling article, an inventory control article, a window sticker, an inspection sticker, a parking permit, and an expiration sticker.

4. The method of claim 1, in which the signage includes a retroreflective sheet and a pressure sensitive adhesive layer.

5. The method of claim 1, in which the signage includes a non-reflective sheet.

6. The method of claim 1, in which the bossing includes a method selected from a group consisting essentially of embossing, debossing, and removing material from the substrate.

7. The method of claim 1, further comprising:
printing on a printable portion of at least one of the substrate and the signage.

8. The method of claim 7, in which the printing is effected by a method selected from a group consisting essentially of digital printing, thermal printing, flexographic printing, letter press, gravure printing, laser printing, ink-jet printing, thermal mass transfer printing, thermal dye transfer printing, electrostatic printing, ion deposition, electron beam imaging, solid ink-jet and dot matrix printing.

9. The method of claim 1, in which the signage is releasably attached to the bossed substrate portion.

10. The method of claim 1, further comprising:
applying a release material to at least a portion of the substrate.

11. The method of claim 10, in which the release material is applied to the bossed substrate portion.

12. The method of claim 10, in which the release material is a printable release material that is applied to substantially all of the first major surface of the substrate.

13. The method of claim 9, in which the signage is adjacent to the release material.

14. The method of claim 1, in which the signage has an upper surface and a lower surface, in which the lower surface is positioned adjacent to the bossed portion, and in which the upper surface of the signage does not appreciably extend above the first major surface of the substrate.

15. A form, comprising:
a substrate having a bossed substrate portion and a unbossed substrate portion; and
a signage adjacent to the bossed substrate portion.

16. The form of claim 15, in which the signage includes one of a sticker, decal, or label adjacent to an adhesive layer.

17. The form of claim 16, in which the signage further includes a release material that is adjacent to the adhesive layer.

18. The form of claim 15, further comprising a release material on at least a portion of the substrate.

19. The form of claim 15, in which the signage has an upper surface and a lower surface and the substrate has a first major surface and a second major surface, and in which the lower surface of the signage is positioned adjacent to the bossed portion and the upper surface of the signage does not extend appreciably above the first major surface of the substrate.

20. The form of claim 15, in which the signage is releasably attached to the bossed substrate portion.
